(19) United States
(12) Patent Application Publication
(10) Pub. No.: US 2019/0169791 A1
(43) Pub. Date: Jun. 6, 2019

(54) METHOD OF COLLECTING, TRANSPORTING AND CLEANING WITH REUSABLE LAUNDRY BAG

(71) Applicant: Cintas Corporate Services, Inc., Cincinnati, OH (US)

(72) Inventors: Tony Bellamy, North Augusta, SC (US); Chad Grooms, Cincinnati, OH (US); Gary Pagenkopf, Bulverde, TX (US)

(73) Assignee: Cintas Corporate Services, Inc., Cincinnati, OH (US)

(21) Appl. No.: 16/140,827

(22) Filed: Sep. 25, 2018

Related U.S. Application Data
(60) Provisional application No. 62/594,615, filed on Dec. 5, 2017.

(51) Int. Cl. D06F 95/00

(52) U.S. Cl. CPC D06F 95/006; B65F 1/1615

(57) ABSTRACT

A method of cleaning soiled textiles utilizes a reusable bag for containing soiled textiles in conjunction with a sling and a wheeled tote to efficiently process soiled laundry in such a cleaning process. The reusable bag does not leave a residue on the soiled textiles during the cleaning process and offers significant cost savings over other cleaning options while still allowing for the safe handling of the soiled textiles in the cleaning process.

This claims priority to U.S. Provisional Application Ser. No. 62/594,615, filed Dec. 5, 2017 and hereby incorporated by reference in its entirety.

### BACKGROUND OF THE INVENTION

This invention relates generally to a method of laundering soiled textiles, and relates specifically to such a method utilizing a reusable laundry bag for collecting, transporting and laundering soiled textiles.

The cleaners of a healthcare facility play a vital role in limiting the spread of infections among patients. In an effort to reduce employee injuries while also improving cleanliness, healthcare facilities are now using lightweight microfiber cleaning products. While reducing employee injuries and improving cleanliness, there remains the desire to further protect the textile service providers who collect, transport and launder the soiled microfiber products. Limiting the providers' exposure to the soiled product will reduce risk of injury and infection.

Traditionally, plastic bags have been used to contain soiled textiles from the healthcare industries. The plastic bags may be small bags, which are then placed in a larger can, or they may be large trash bags placed in cans. Typically, the provider picks up the bags by hand and transfers them to a truck. While carrying flimsy plastic bags, the provider is at risk of needle sticks and exposure to pathogens if the plastic bag tears. The provider then hauls the bags to the central laundry facility, where they are unloaded. Employees rip open the bags and dump the soiled textiles into a washing machine or into a sling, a potential exposure path for the worker to sharps and pathogens. Additionally, disposal of bacteria-laden bags becomes a major problem, and landfill sites are increasingly burdened with materials such as plastic bags.

Solutions to these problems are disclosed in U.S. Pat. Nos. 8,435,311 and 8,691,257, each incorporated by reference herein in its entirety. These patents disclose a sling having an open end disposed in a container. Soiled textiles are deposited in the sling in the container. When the sling and container are full, they are transported to a laundry facility where the sling and soiled textiles are removed from the container by a crane and ultimately the soiled textiles are deposited out of the sling and into a washing machine for cleaning.

These patents also disclose a water-soluble bag within the sling into which the soiled textiles are deposited and held. The water-soluble bag holds the textiles and is likewise deposited into the washing machine where it dissolves in the washing process. However, the water-soluble bag can leave unwanted residue on the laundered textiles and may leak in the totes or containers or in the sling transfer process.

What is needed is a method of handling and cleaning soiled textiles that decreases occupational exposure to chemicals and pathogens, and decreases the potential for injuries to healthcare cleaning workers and providers while avoiding residue on the laundered textiles and added mess and exposure to the workers. Thus, a systematic process for protecting the service providers and processing and cleaning the soiled healthcare facility textiles is needed.

### SUMMARY OF THE INVENTION

This invention relates to the use of a reusable bag for containing soiled textiles. In one embodiment, the bag has an open end, a closed end, and sides extending therebetween. The method also includes the use of retention straps to secure the bag in a tote or container.

This invention further relates to the use of a receptacle for collecting soiled textiles, comprising a container having an open end, a closed end, and sides extending therebetween, the use of a sling having an open end, a second end, and sides extending therebetween, being disposed inside the container, and the use of a reusable bag having an open end, a closed end, and sides extending therebetween, being disposed inside the sling.

One advantage offered by the use of reusable bag over the prior art is that it does not leave unwanted residue on the laundered products and offers a significant cost savings because the bag is reusable. It is estimated that the reusable bag will result in an annual cost savings of over $480 per tote with an average savings of $3.73 per use over the prior art water soluble bags.

Moreover, operational efficiencies are realized with this invention due to the elimination of the leaks from the bag and of cleaning the totes or containers when the prior art water soluble bags leak or slip entirely into the tote. The reusable bags of this invention have passed the Hohenstein Institute's criteria for hygienic cleanliness when processed with the CDC Healthcare formula.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIGS. 1-3 are views of a reusable bag of various embodiments of this invention;

FIG. 4 is a view of the interior of a portion of one of the bags from FIGS. 1-3 showing a pair of retention straps;

FIG. 5 is a perspective view of a container of one embodiment of the invention with the lid in the open position;

FIG. 6 is a perspective view of the container of FIG. 5 with the lid in the closed position;

FIG. 7 is a perspective view of a sling of one embodiment of this invention;

FIG. 8 is a perspective view of a reusable bag being inserted into the sling in the container;

FIG. 9 is a perspective view of the container of the invention lined with a sling and a reusable bag;

FIG. 10 is a perspective view of the retention straps on the reusable bag being secured to the container;

FIGS. 11-13 are perspective views of an upper portion of the reusable bag being wrapped around an upper portion of the container;

FIG. 14 is a perspective view of the lid of the container being secured closed after soiled textiles have been deposited into the reusable bag and sling in the container;

FIG. 15 is a perspective view of the retention straps being released after the container and soiled textiles have arrived at a washing facility;

FIGS. 16-18 are perspective views of the upper portion of the reusable bag being released from the upper portion of the container and inserted into the sling in the container;

FIG. 19 is a perspective view of the sling of the invention containing a reusable bag with soiled textiles therein being removed from the container;

FIG. 20 is a perspective view of the reusable bag of the invention containing soiled textiles released into a washer; and

FIG. 21 is a perspective view of a washing machine, washed laundry transfer mechanism, and dryer.

### DETAILED DESCRIPTION OF THE INVENTION

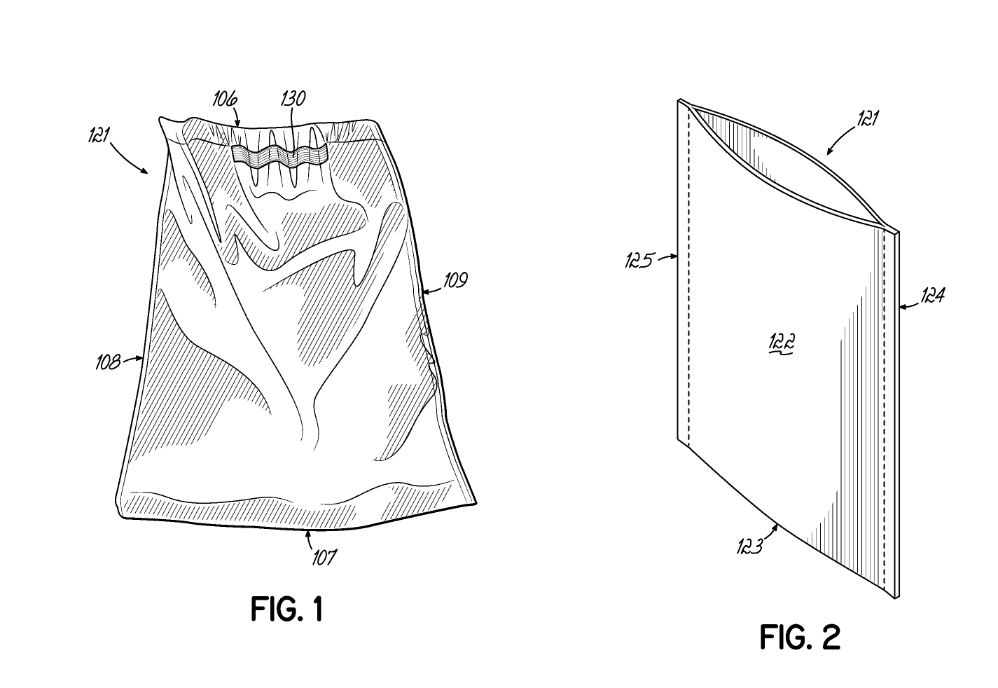

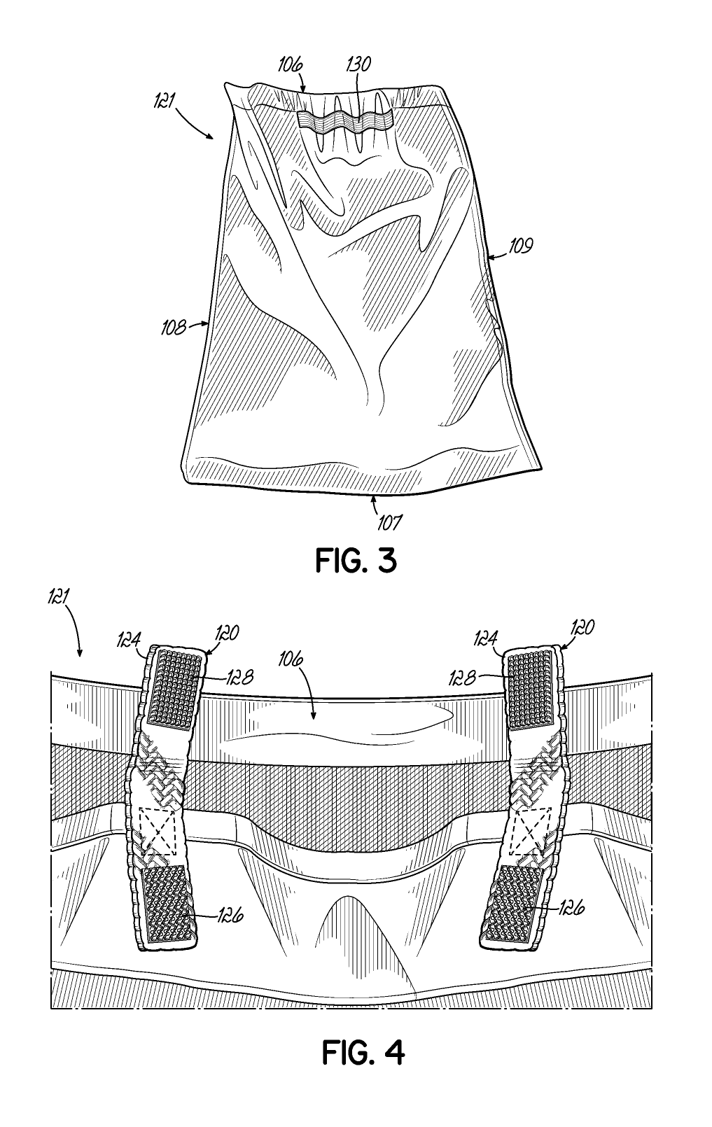

FIGS. 1-3 illustrate a reusable laundry bag 121 according to one embodiment of this invention constructed from a single sheet by folding a sheet 122 of generally rectangular configuration along a bisecting line 123 and seaming the bag at its sides 124, 125. The bag 121 has an open end 106, a closed end 107, and sides 108 and 109 therebetween. While the bags in FIGS. 1-3 are depicted as rectangular in shape, it will be understood that it may be made in any desired shape. For example, it will be appreciated that the bag 121 may be constructed from a generally tubular body provided with such a seam at the bottom of the bag. The bag 121 may also be reinforced to decrease the risk of leakage during handling. For example, an extra sheet may be added to the bottom of the bag, where the liquids are most likely to accumulate and cause the bag to prematurely rupture.

The reusable bag 121 may be constructed of Yuma HS-LD409 200 denier coated nylon available from Industrial Bag & Specialties, Inc. of Southfield, Mich. 48075, www.industrialbag.com, although many other materials may be used for the bag according to this invention.

The bag 121 should be large enough to contain at least 175 lbs. of soiled textiles 100 and have capacity of at least 50 gallons. The bags 121 may hold up to 500 lbs. of laundry 100 and may have a capacity of up to 100 gallons. Various compositions known to those of ordinary skill in the art may meet this requirement.

The bag 121 may be colored or may comprise different markings or patterns on the surface. The colors may indicate to the user the type of soiled laundry 100 contained therein. The patterns are typically made from dyes that are not fabric substantive and do not transfer to the soiled laundry 100 during storage of the laundry in the bag or during the washing process. Alternatively, the patterns may be embossed and/or printed on the bag.

As shown most clearly in FIG. 4, the bag 121 according to various embodiments of this invention includes a pair of retention straps 120 secured to an inside surface along a back edge of the bag 121. The retention straps 120 each include an elongate piece of heavy-duty material 118 and extend beyond the upper edge of the bag. Each retention strap 120 includes two connecting portions 126, 128 which may cooperate with one another to secure the bag. The connecting portions 126, 128 according to various embodiments of this invention may be hook and loop fasteners with one portion of the hook and loop fastener on one section of the strap and the complimentary hook and loop fastener section on the other end of the strap 120 such that the strap 120 may be folded on itself and secured by the hook and loop fastener connection. The bag 121 may also include an elastic loop strap 130 extending most, if not all, of the upper edge or hem of the bag 121.

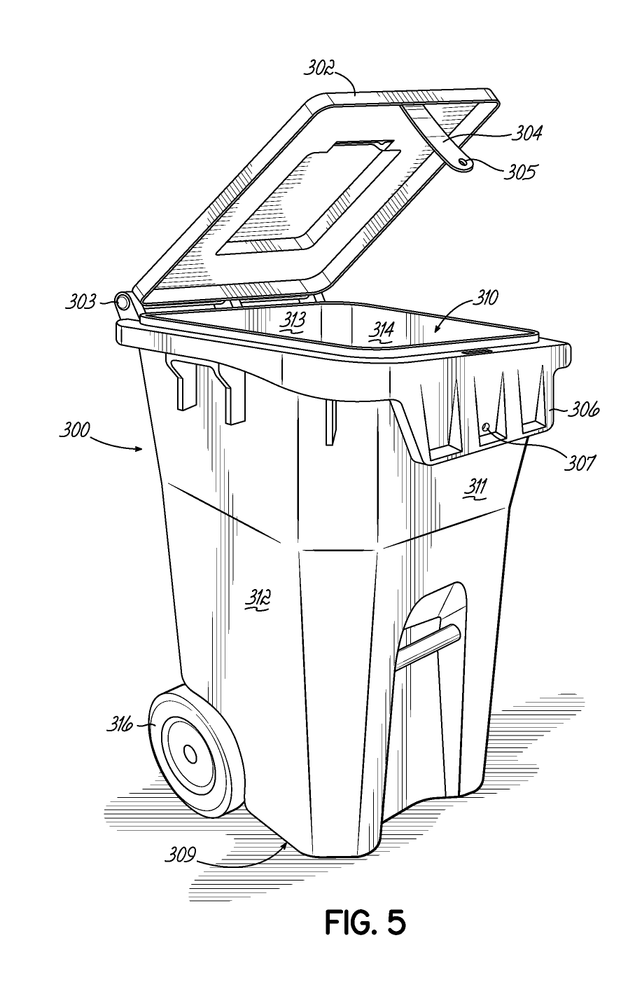

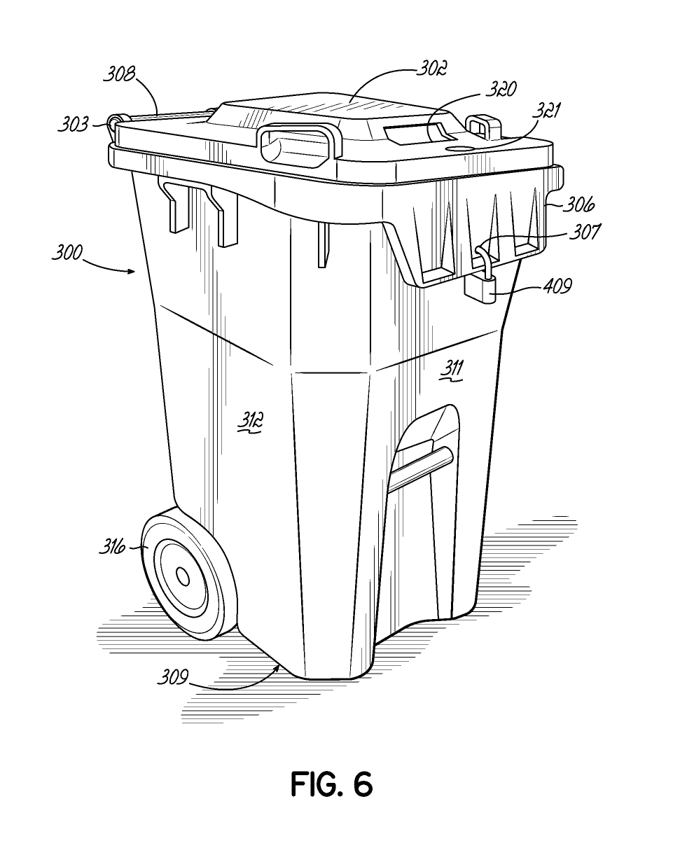

Another aspect of this invention is shown in FIG. 5 and is a container or wheeled tote 300. Container 300 shown in FIG. 5 includes a body having an open end 310, a closed end 309, sides 311, 312, 313 and 314 and a lid 302 that is pivotally attached to a rear side of the body by a hinge 303. The hinge 303 may incorporate a handle 308 for the wheeled container 300. At the front of the lid 302 there is mounted a downwardly extending elongated tongue 304 having an aperture 305 in the vicinity of its free end. An apron 306 extends around the top of the open end of the container. Referring to FIG. 6, the tongue 304 has an enlarged head 321 positioned snugly against the upper side of the lid and passes through a slot (not shown) in the lid, the tongue being secured to the lid with respect to this slot. The lid is also supplied with an opening 310 for receiving soiled textiles 100.

With the lid 302 in the closed position, the tongue 304 extends downwardly immediately behind the apron 306 so that the aperture 305 in the tongue 304 registers with the aperture 307 (see FIG. 6) in the apron 306. In this position, a padlock 409 can be threaded from behind the apron through the registering apertures 305 and 307 and the padlock secured to lock the lid 302 in the closed position. Wheels 316 may also be provided on the container 300 to allow for easier transportation of the container.

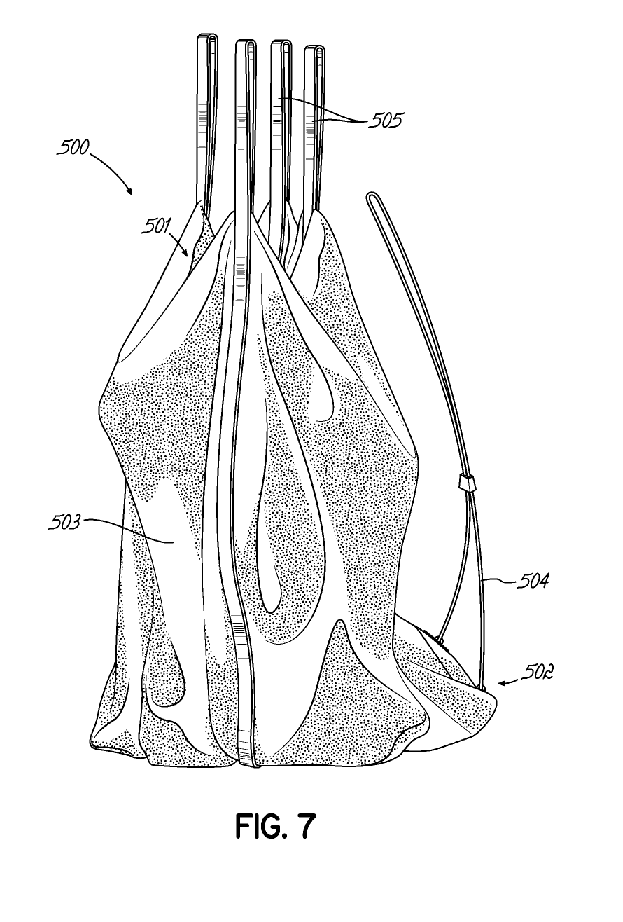

Referring now to FIG. 7, another aspect of various embodiments of this invention is a sling 500. The sling has an open first end 501, an open second end 502, and side walls 503. The second end 502 may be cinched closed to support the bag 121 containing soiled textiles. In the embodiment shown in FIG. 7, a drawstring 504 is used to cinch the second end 502 closed. Straps 505 extend upwardly from open end 501 and downwardly along the side walls 5036 to support the sling 500.

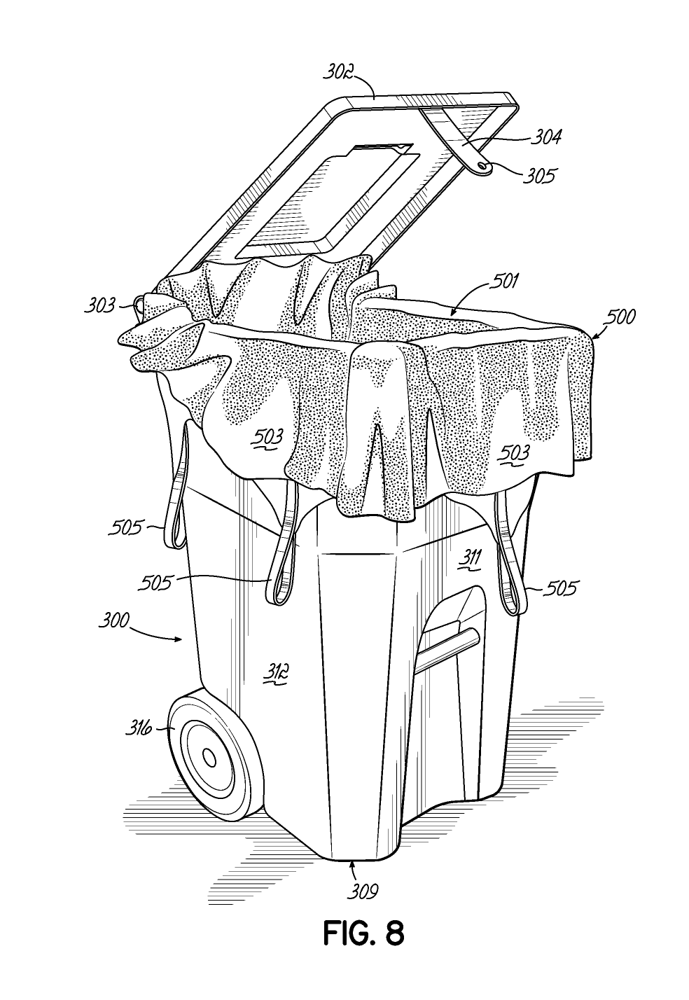

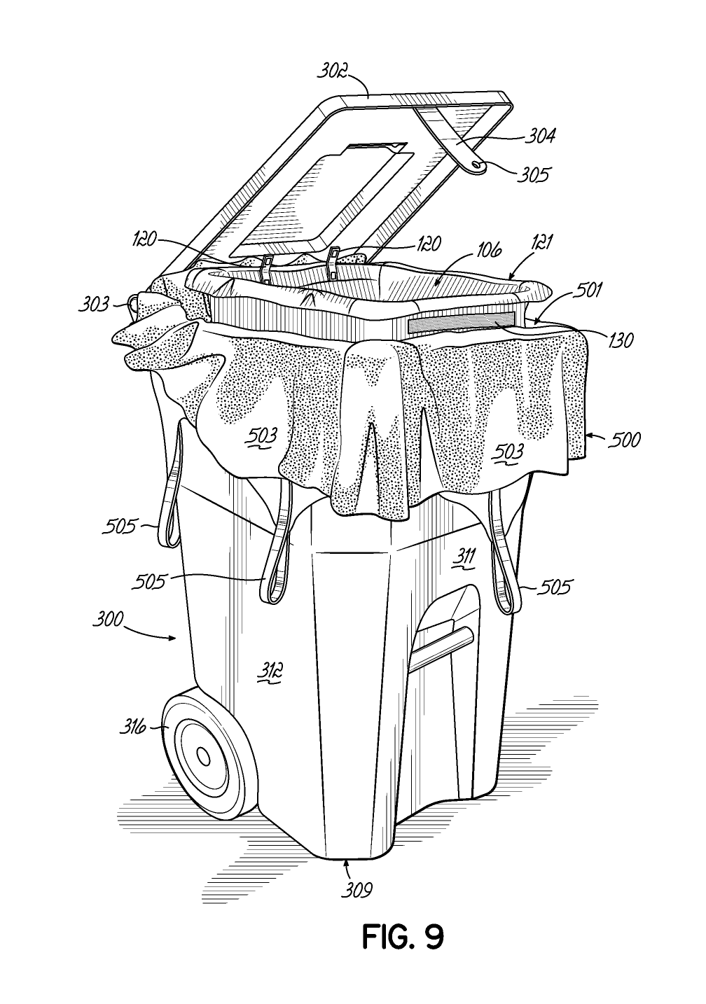

In the embodiment shown in FIGS. 8-9, the container 300 receives the sling 500 and the bag 121. An unshown side and sides of the open end of the sling 500 and the sides of the open end of the bag 121 are folded over the top of the container 300 as shown in FIG. 8. To close the lid 302, the side of the bag 121 and the side of the sling 500 may be folded to allow the tongue 304 to pass by the bag 121 and sling 500. The lid 302 of the container 300 is then closed and locked. The lid 302 of the container 300 serves to secure the sling 500 and bag 121 in place. The user may provide a second bag inside the first bag if additional protection is desired.

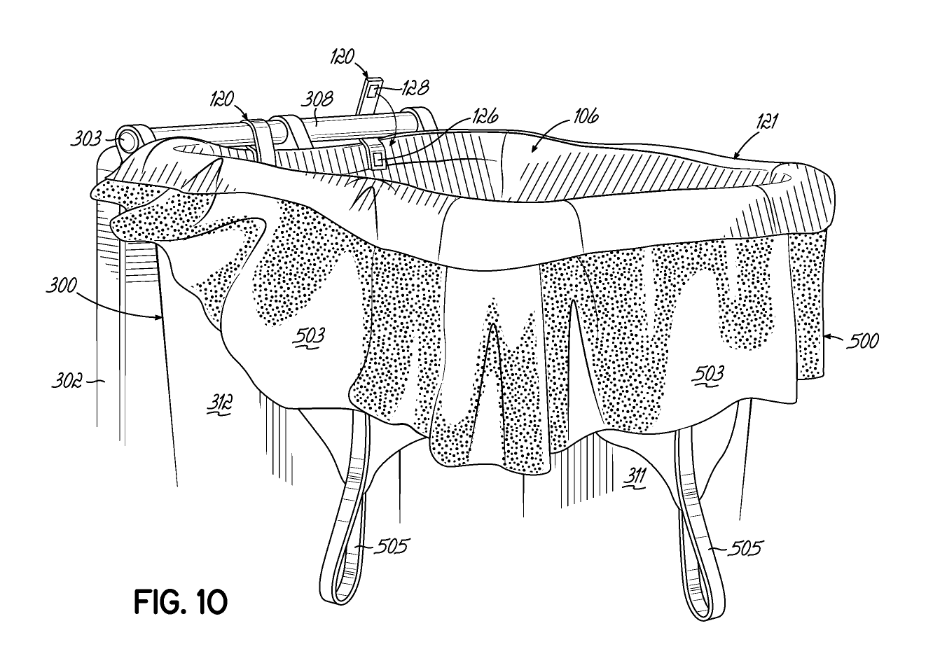

As shown most particularly in FIG. to, once the bag 121 is inserted into the sling 500 within the container 300, the retention straps 120 are secured to the handle 308 of the container 300. Each retention strap 120 is extended and wrapped around the handle 308 and then the securing sections 126, 128 of each retention strap 120 are secured together to thereby secure the bag 121 to the handle 308 of the container 300 as shown in FIG. 10.

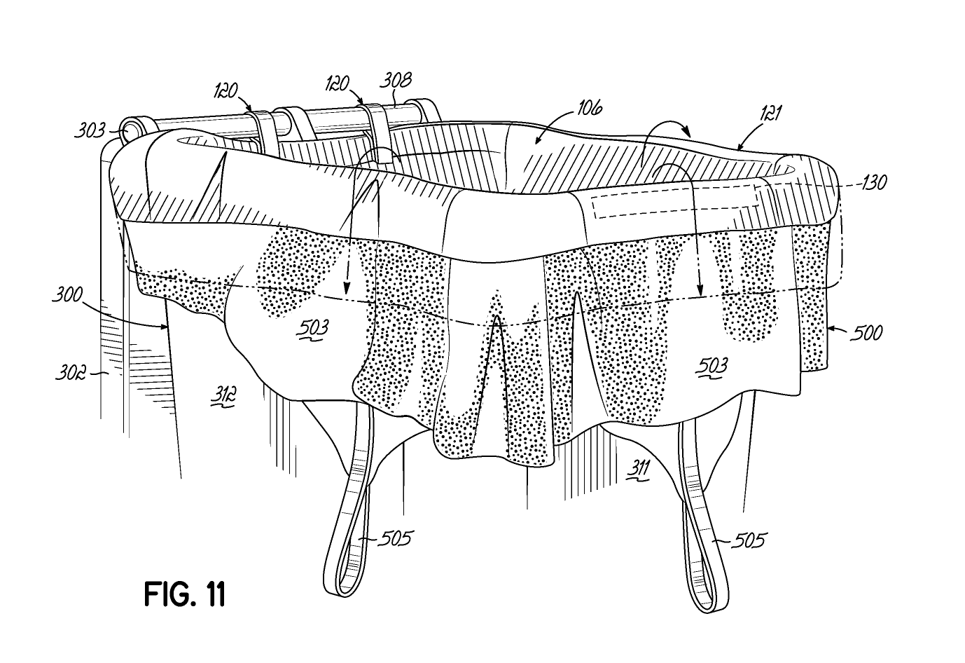

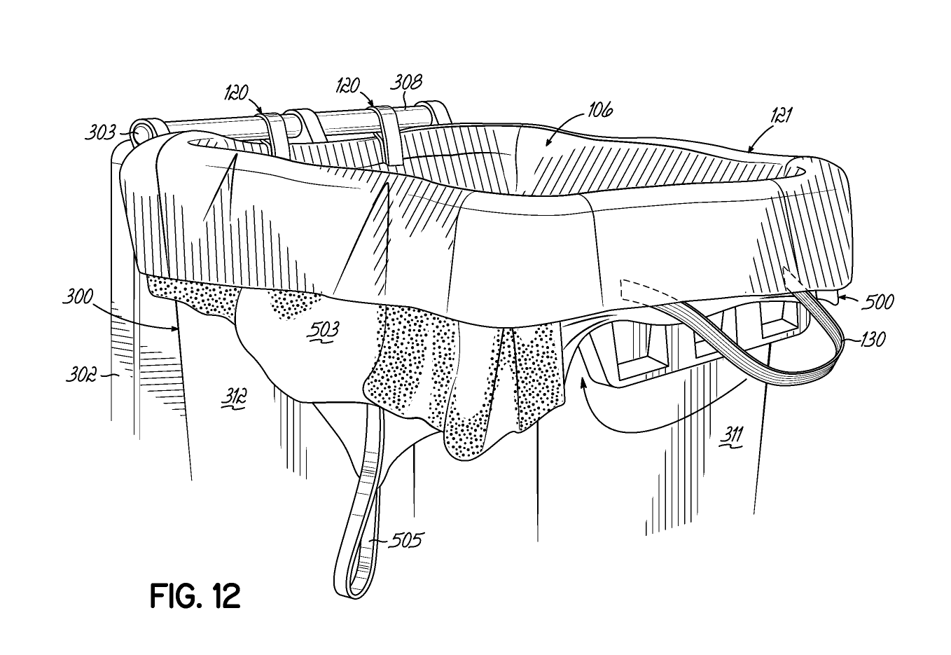

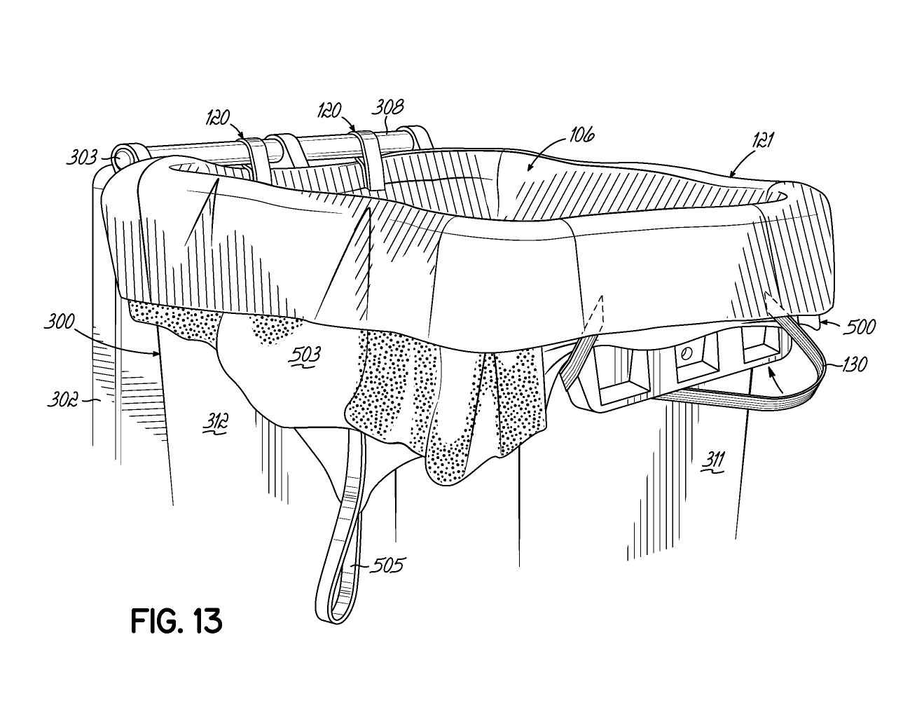

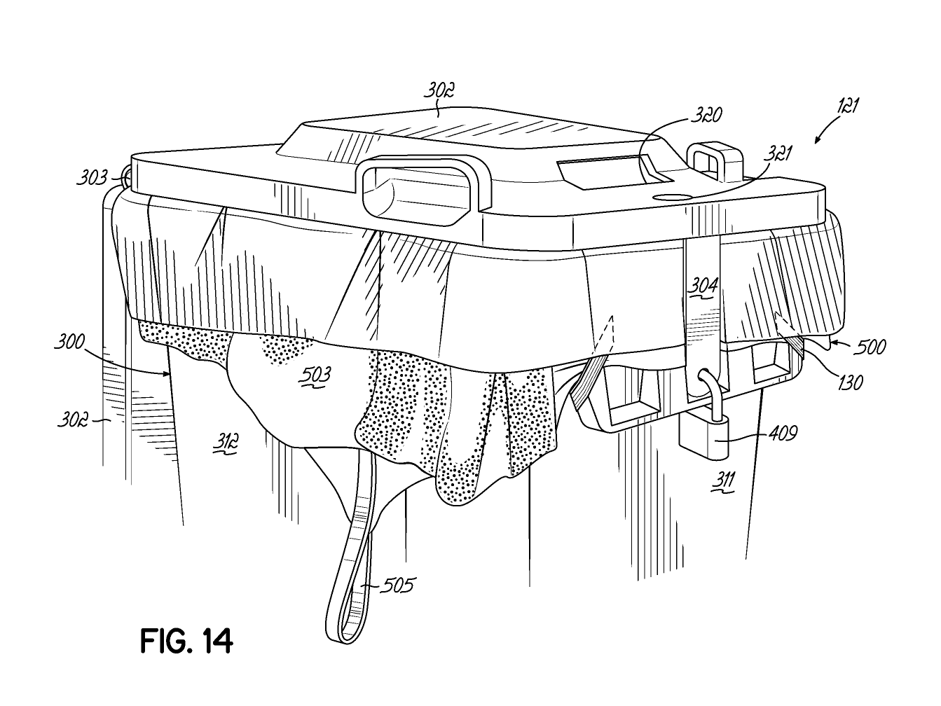

Referring to FIGS. 11-13, once the retention straps 120 are secured to the handle 308 of the container 300, the upper portion of the bag 121 is wrapped around the front two corners of the apron 306 on the container opposite the handle 308 (FIG. 11). The elastic loop strap 130 which may be part of the bag 121, the sling 500 or an additional component of the invention may be then secured over the front apron 306 of the container 300 as shown dearly in FIG. 12. Once the front edge of the upper apron of the container 300 is covered by the bag 121, the bag 121 is then pulled around the remaining upper edge of the container 300 as shown more dearly in FIG. 13. The elastic loop strap 130 may be completely wrapped around the front and then the back of the container 300.

In one operation of the invention, the textile service provider supplies the container 300 containing the sling 500 and bag 121 to the healthcare facility. Typically, the container lid 302 is locked using the tongue 304 and a padlock 409, such as the padlock in FIG. 6, securing the sling 500 and bag 121 in the container 300 before delivering the assembly to the healthcare facility. The container 300 may be marked with labels regarding appropriate textiles 100 to place therein. The provider may spot the container 300 at a collection location at the healthcare facility, or may deliver the container 300 to a central location at the facility. In addition to the container 300, the provider may deliver clean microfiber mops and other textiles to the healthcare facility.

The healthcare cleaners use mops and other textile cleaning products, such as microfiber textiles, in their daily cleaning activities. The cleaners place soiled microfiber textiles in an opening provided in the lid 302 of the container 300. As discussed previously, the bag 121 is of sufficient thickness and design so that it will support the soiled textiles 100 that may be wet from cleaning products.

On a regular basis, the provider retrieves the container 300 holding the soiled textiles 100 from the healthcare facility and delivers another container 300 preloaded with the sling 500 and bag 121 to the healthcare facility. The container 300 containing soiled textiles 100 is loaded onto the truck and delivered to a central washing facility. Other means of transporting the container 300 holding the soiled textiles 100 may also be used. For instance, if the laundry facility is located within the healthcare facility, then the container 300 may simply be wheeled to the laundry facility.

Upon arriving at the central laundry facility, the provider moves the container 300 from the truck to a staging area. The containers 300 are sorted according to the materials contained therein. For example, microfibers must be kept separate from other textiles. If washed together, the fibers of traditional textiles will fill the voids in the microfiber, rendering the microfiber ineffective. Thus, it is essential that microfiber be kept separate from other cleaning textiles. The provider may use color coded liners, slings, or containers to assist in sorting the containers.

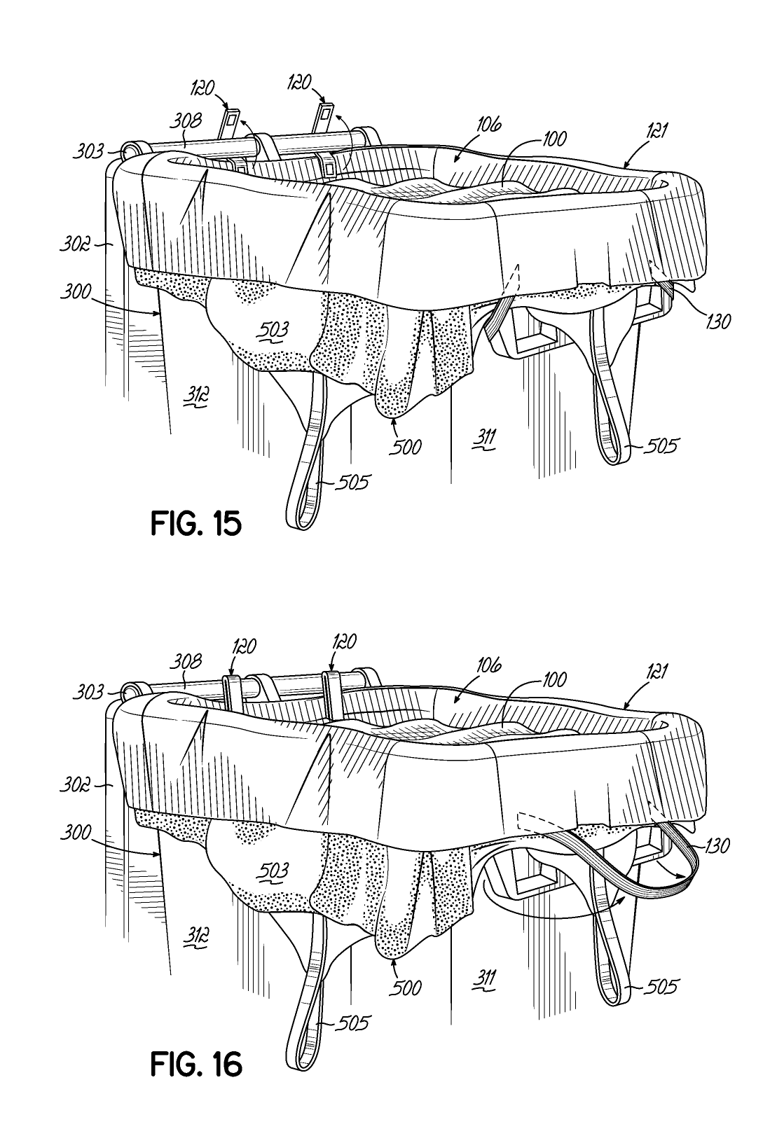

Once the soiled laundry 100 within the bag 121 within the sling 500 within the container 300 arrives at the laundry facility, the lid 302 of the container 300 is opened by unlocking the padlock 409 to release the lid 302 from the body of the container 300. As shown in FIG. 15, after the lid 302 is opened, the retention straps 120 will be removed from the handle 308 of the container 300. It is advised that each retention strap 120 should be secured to itself once it is removed from the handle 308 of the container 300 so that the hook and loop fastener sections 126, 128 do not become fouled or damaged during the laundry process. The accumulation of lint is a common phenomenon when the hook and loop fasteners are exposed during the laundry process.

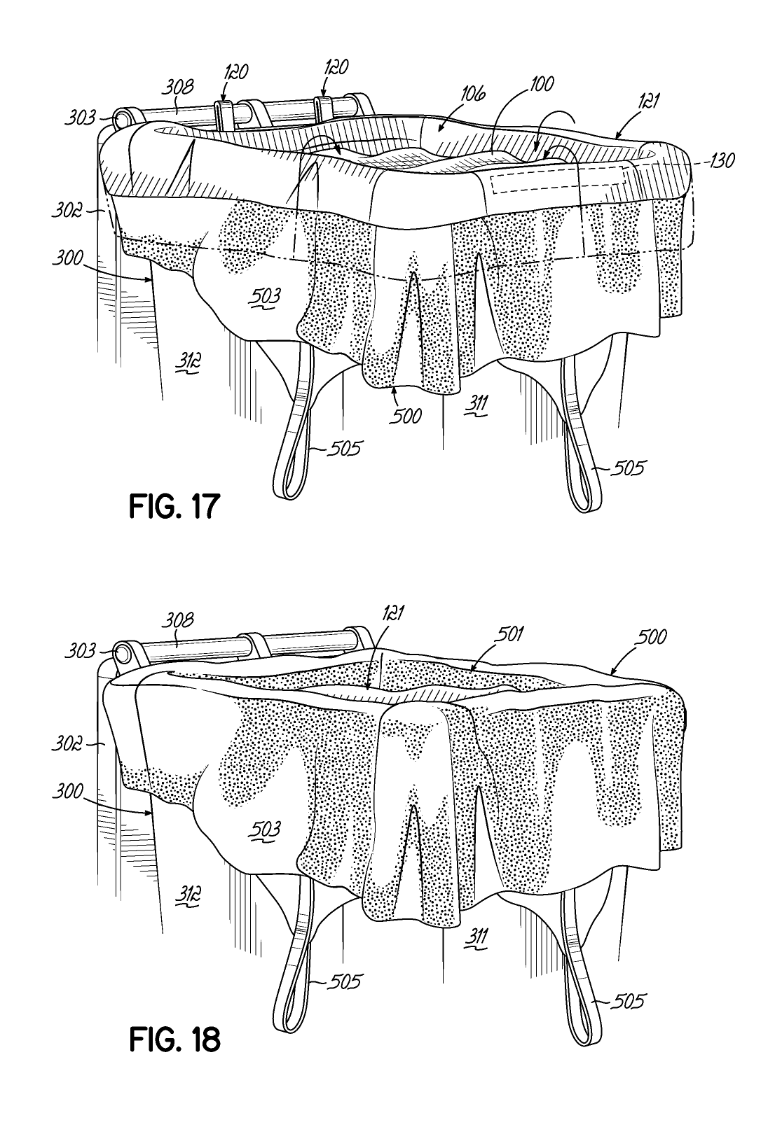

A shown in FIG. 16, the front then the back corners of the bag 121 and the elastic loop strap 130 are released from the container 300 and, as shown in FIGS. 17-18, the bag 121 is tucked into the sling 500 entirely while the sling 50o remains in the container 300.

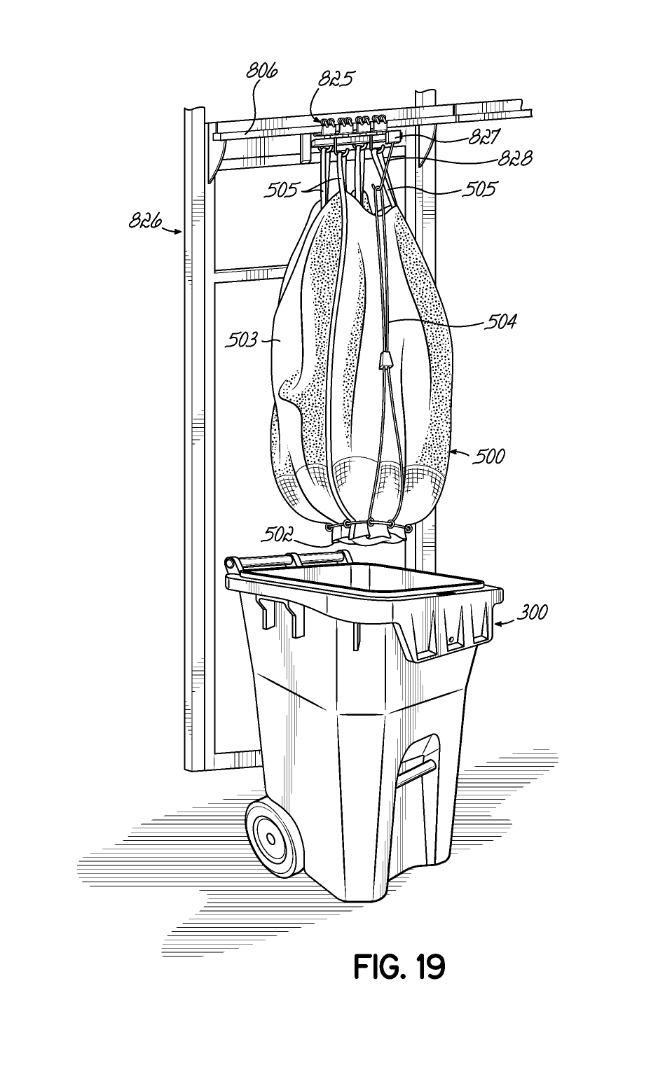

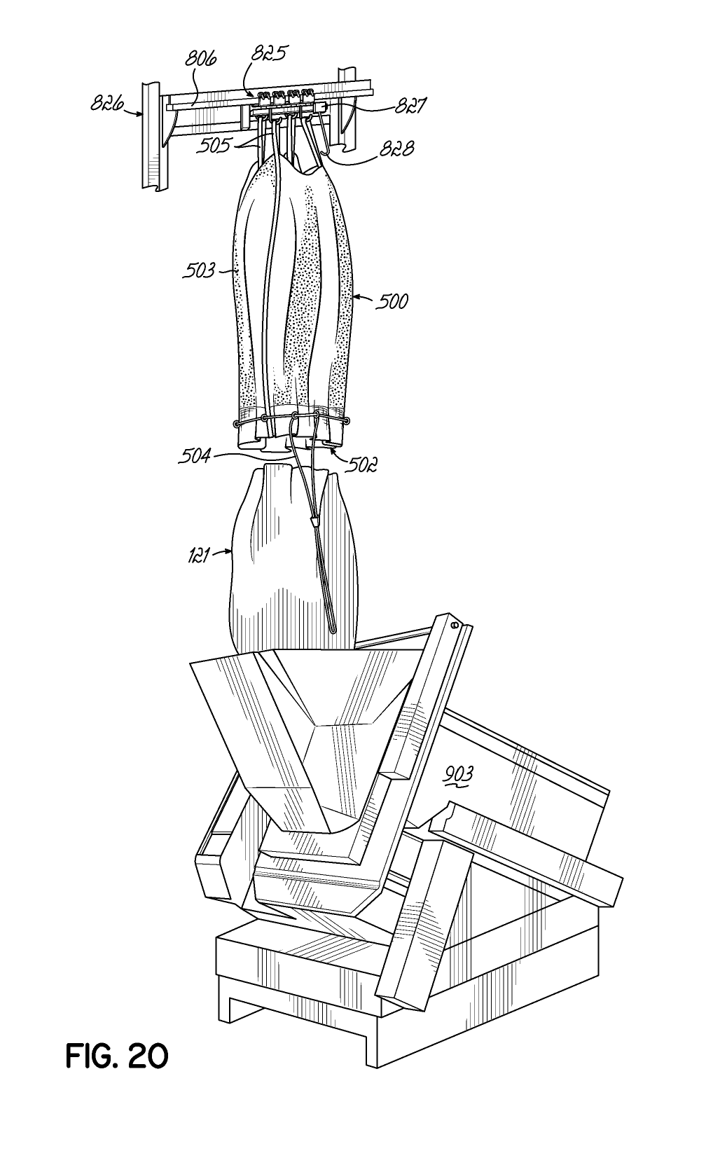

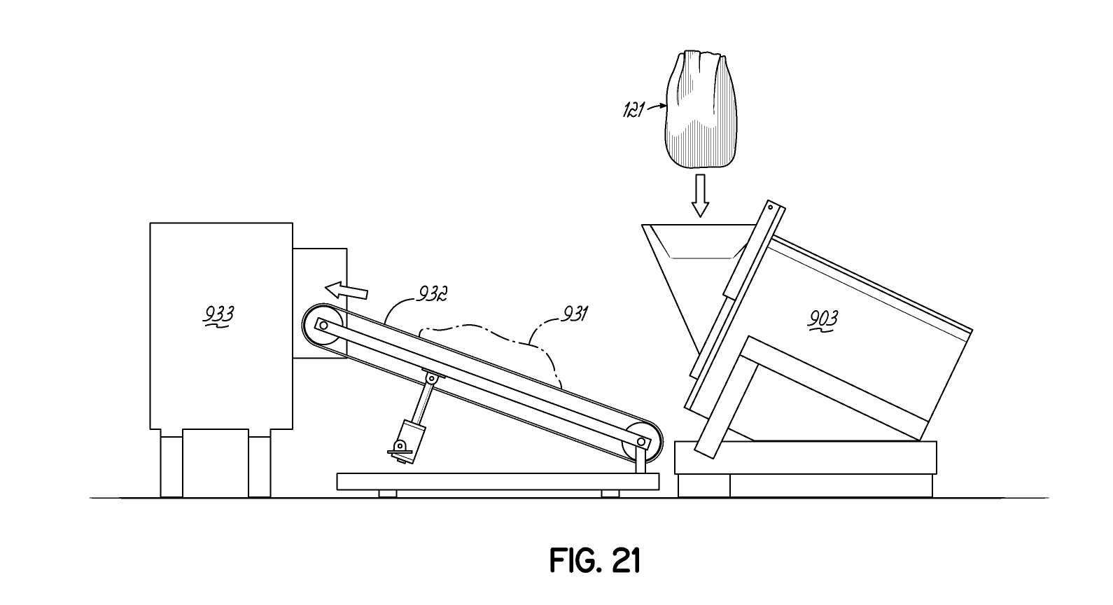

At the central laundry facility, an employee wheels the container 300 holding the sling 500, the bag 121, and soiled textile products under an unloading device as shown in FIG. 19. The employee may don personal protective equipment (PPE), as required. Loops 821, 822, 823 and 824 are disposed on a hook mechanism 825 located on a crane 826. Additionally, a release cord 828 for a cinched end 802 of the sling 801 is hooked onto an automated release mechanism 827. The sling 5oo is then raised out of the container 300, and stopped just above the container. An end 802 of the sling 500 remains cinched closed to support the bag 121. Typically, the sling 500 would be stopped at a height of 4-6 feet above the ground. Prior to sending the sling 500 and textiles 100 to the washing area, an associate may check the sling 500 and bag 121 for any leakage. If leaks are found, the sling 500 is returned to the container 300. The associate then obtains a second container 300 preloaded with an empty bag 121 and sling 500 (similar to the system of FIG. 7), raises the sling 500 containing the soiled textiles 100 out of the first container 300, moves the second container 300 under the leaking sling 500, opens the bottom of the sling 500, and transfers the bag 121 and soiled textiles into the second container 300. Additionally, the first container 300 holding the sling 500 may be disinfected using a bleach solution, with the container surfaces kept moist with the bleach solution for at least 10 minutes. If the bag 121 has leaked, the sling 500 typically is washed. The sling 500 is washed separate from the microfiber products to prevent fibers from the sling filling the voids of the microfiber products, rendering them ineffective. The operator then sends the sling 500 with soiled textiles 100 and bag 121 to the wash room. The sling 500 travels on a rail 806 to a staging area, and finally to a washing machine. However, the reusable bag 121 of this invention reduced and/or eliminates leakage compared to the prior art.

As shown in FIG. 21, the sling 500 travels along a rail 806, stopping at a position above a washing machine 903. An automated release mechanism 827 releases the bag 121 and the soiled textiles 100 therein into the washing machine 903. Depending upon the washing machine's capacity, a single load may consist of multiple bags 121 containing soiled textiles 100.

Pursuant to the Center for Disease Control Guidelines for hospital laundry, the soiled textiles 100 are washed in 160° F. water for 25 minutes with 50-150 PPM total available chlorine. More typically, the textiles are washed at 165° F. for 25 minutes, followed by 8 minutes of washing at 145° to 150° F. in a chlorine solution containing 5-12 ounces of 10-12% chlorine bleach per hundred weight of soiled product. The load is then rinsed using three 2-minute rinse cycles, one with hot water, typically 130° F., followed by two cycles of cold water, or water less than 90°.

Once the bag 121 with the soiled textiles 100 enters the washing machine, the time it takes for the bag 121 to release its contents depends generally on the contents and design of the bag, but also on a number of other factors such as the quantity of liquid contained in the bag, the weight and nature of the load which is placed in the bag, and the functional characteristics of the washing machine. Typically, the bag 121 releases its contents within 90 seconds of entering the washing machine. The bag 121 may be used with both front-loading and top-loading automatic washing machines and also with non-automatic washing machines.

After the textiles are washed, they are transferred to a dryer 933. As shown in FIG. 21, washed textiles 931 are unloaded from the washing machine 903 onto a conveyor system 932. The conveyor system 932 transfers the textiles to the dryer 933. Other systems for transferring the washer textiles from the washing machine to the dryer 933 may be utilized. For example, if the facility does not have a conveyer system available, the unloading of the washing machine and transferring to the dryer may take place by hand. After drying, the textiles are sorted and checked for foreign objects, such as a foreign textile or sharps.

Under ordinary operating conditions, as the above description shows, the provider does not touch the soiled textiles. The soiled textiles are confined in the bag 121 and sling 500 from the time they are collected until they exit the washing machine 903. Only then, after the textiles are disinfected, washed, and dried, are they checked for foreign objects, such as needles. Even if a needle stick occurs, the risk of infection is virtually eliminated because the needle has been through the wash and disinfecting cycle. The reduced handling of the soiled textiles described herein reduces a providers' exposure to pathogens.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. A method of collecting soiled textiles to be cleaned, comprising the steps of:
providing a container having an open end, a closed end, and sides extending there between;
providing a sling having an open end, a second end having an opening that can be selectively closed, and sides extending there between disposed in and supported by said container;
providing a reusable bag having an open end, a closed end, and sides extending there between and being capable of containing at least 175 lbs. of soiled textiles, and having a capacity of at least 50 gallons;
disposing said bag in said sling, the closed end of said bag being supported by said second end of said sling when said opening of said second end is closed;
disposing said bag in said sling into said container; and
depositing soiled textiles in said container contained in said bag.

2. The method according to claim 1, further comprising the step of:
mounting a lid on said container.

3. The method according to claim 2, wherein said lid has an opening for receiving soiled textiles.

4. The method of claim 2 further comprising:
locking said lid closed on said container with said bag and said sling therein.

5. The method of claim 1 further comprising:
marking said bag to indicate a type of soiled textiles to be deposited in said marked bag.

6. The method of claim 1 further comprising:
releasably securing said bag to said container when said bag is disposed in said container.

7. The method of claim 6 wherein said releasably securing step further comprises:
wrapping straps extending from said bag around a portion of said container.

8. The method of claim 1 further comprising:
folding a portion of said bag proximate said open end over a lip of said container, said lip bounding said open end of said container.

9. The method of claim 1 further comprising:
folding a portion of said sling proximate said open end over a lip of said container, said lip bounding said open end of said container.

10. The method of claim 1 further comprising:
lifting said sling and said soiled textiles from said container so as to deposit said soiled textiles in a washing machine.

11. The method of claim 10 wherein said lifting step is accomplished without human contact with said soiled textiles.

12. The method of claim 1 further comprising:
determining if said bag containing said soiled textiles has any fluid leaking therefrom; and
if said bag has fluid leaking therefrom, inserting said bag with said soiled textiles therein into a second bag so as to contain the fluid leaking from said bag.

13. A method of collecting and cleaning soiled textiles from a facility, comprising the steps of:
providing to said facility a container having an open end, a closed end and sides extending there between;
a sling disposed in and supported by said container and having an open end, a second end having an opening that can be cinched closed, and sides extending there between; and
a bag disposed in and supported by said sling and having an open end, a closed end, and sides extending there between and being capable of containing at least 175 lbs. of soiled textiles, and having a capacity of at least 50 gallons;
wherein said bag is disposed in said sling, the closed end of said bag being supported by said second end of said sling when said opening of said second end is cinched closed;
collecting in said bag soiled textiles from said facility, transporting said container, sling, bag, and soiled textiles from a facility to a laundry;
unloading said sling, bag, and soiled textiles from said container at the laundry;
unloading from said sling through said opening at said second end said bag and the soiled textiles into a washer; and
washing and drying the soiled textiles.

14. The method according to claim 13, further comprising the step of mechanically unloading said sling from said container.

15. The method of claim 14 wherein said unloading step is accomplished without human contact with said soiled textiles.

16. The method according to claim 13, further comprising the step of providing clean textiles to the facility.

17. The method according to claim 13, wherein the textiles are microfiber products.

18. The method according to claim 13, wherein said facility is a healthcare facility, a detention facility, a daycare facility, a nursing home, or a laboratory facility.

19. The method according to claim 13, further comprising the step of inspecting said sling and said bag for leakage.

20. The method of claim 13 further comprising:
re-using the bag in a subsequent cleaning cycle of additional soiled textiles.

21. The method of claim 13 further comprising:
determining if said bag containing said soiled textiles has any fluid leaking therefrom; and
if said bag has fluid leaking therefrom, inserting said bag with said soiled textiles therein into a second bag so as to contain the fluid leaking from said bag.

22. The method of claim 13 further comprising:
releasably securing said bag to said container when said bag is disposed in said container.

23. A method of collecting and cleaning soiled textiles from a facility, comprising the steps of:
providing to said facility a container having an open end, a closed end and sides extending there between;
a sling disposed in and supported by said container and having an open end, a second end having an opening that can be cinched closed, and sides extending there between; and
a bag disposed in and supported by said sling and having an open end, a closed end, and sides extending there between and being capable of containing at least 175 lbs. of soiled textiles, and having a capacity of at least 50 gallons, wherein the textiles are microfiber products;
wherein said bag is disposed in said sling, the closed end of said bag being supported by said second end of said sling when said opening of said second end is cinched closed;
collecting in said bag soiled textiles from said facility, transporting said container, sling, bag, and soiled textiles from a facility to a laundry;
inspecting said sling and said bag for leakage;
mechanically unloading said sling, bag, and soiled textiles from said container at the laundry;
unloading from said sling through said opening at said second end said bag and the soiled textiles into a washer;
washing and drying the soiled textiles; and
providing clean textiles to the facility, wherein said facility is a healthcare facility, a detention facility, a daycare facility, a nursing home, or a laboratory facility.

24. The method of claim 22 further comprising:
re-using the bag in a subsequent cleaning cycle of additional soiled textiles.

25. The method of claim 22 further comprising:
releasably securing said bag to said container when said bag is disposed in said container.
